(19) United States
(12) Patent Application Publication
(10) Pub. No.: US 2013/0024492 A1
(43) Pub. Date: Jan. 24, 2013

(54) Event Tracking and Messaging System and Method

(71) Applicants: John E. Graff, Provo, UT (US); Bruce G. Hassler, Mapleton, UT (US); Stephen T. Jibson, Lehi, UT (US); Thomas E. Lane, Spanish Fork, UT (US); Daniel B. Stovall, Provo, UT (US); Tyson L. Holmes, American Fork, UT (US); Jacob S. Hutchings, Provo, UT (US)

(72) Inventors: John E. Graff, Provo, UT (US); Bruce G. Hassler, Mapleton, UT (US); Stephen T. Jibson, Lehi, UT (US); Thomas E. Lane, Spanish Fork, UT (US); Daniel B. Stovall, Provo, UT (US); Tyson L. Holmes, American Fork, UT (US); Jacob S. Hutchings, Provo, UT (US)

(73) Assignee: PARLANT TECHNOLOGY, INC., Provo, UT (US)

(21) Appl. No.: 13/188,393

(22) Filed: Jul. 21, 2011

(51) Int. Cl. G06F 15/16

(52) U.S. Cl. 709/202

(57) ABSTRACT

The various implementations of the present invention are provided as a network computer system configured to allow for the tracking and reporting of user-specified events, including but not limited to, performance metrics and attendance data. This network computer system provides a user interface that allows a user to create metrics to be monitored, view and update event-related information, and to configure and review various pre-programmed and ad hoc reports so the users can monitor and evaluate performance metrics over time. Further, a wide variety of user and system generated alerts and messages or message events can be configured, allowing for automated and manual messaging related to the attendance or performance metrics that are being monitored. Alerts can be provided via email, non-electronic mail, telephone, SMS, facsimile, social networking sites and services (such as “tweets”), etc. In at least one implementation of the present invention, a computer-implemented method of tracking and reporting student performance and attendance-related events for an educational environment is provided.

### BACKGROUND OF THE INVENTION

1. Technical Field

The present invention relates generally to the field of communication and messaging and more specifically relates to equipment and methods for tracking user-specified events, as well as generating and providing event-related messages and reports to interested parties.

2. Background Art

Schools, businesses, government agencies, and others will often track various metrics in order to gauge performance and to make certain operational and policy decisions. Attendance tracking, for example, is a commonplace activity for many businesses, government agencies, schools, churches, etc. As used herein, “attendance tracking” refers to accumulating data on the attendance or non-attendance of an individual or group of individuals at school, work, entertainment venues and the like. Attendance tracking may also include tracking time of arrival information as well as the duration of time of attendance at a specific venue or activity.

There are numerous purposes behind attendance tracking activity. For example, a company may use attendance and absenteeism numbers to determine whether or not employees are “on the job” as required or to analyze attendance trends relative to achieving operational objectives. Schools may be required to track attendance to comply with government mandated attendance requirements and to provide information for statistical analysis. In general, organizations will track and analyze attendance data to assist them in furthering their objectives, whatever they may be.

There are a wide variety of known systems and processes available for attendance tracking and reporting. These include both manual and automated systems, with many computerized attendance tracking and reporting systems now being offered by various companies. Computerized attendance tracking and reporting systems can be used to generate email messages to send alerts to one or more interested parties regarding the attendance figures. Some systems include automated phone calling features as well.

Many businesses and schools have adopted and implemented computerized attendance tracking and reporting systems, with varying degrees of success. In most cases, the computerized attendance tracking and reporting systems are limited to the specific functions and features that have been pre-designed by the makers of the system and provide little opportunity for customization. However, since the attendance tracking and reporting function is vital for many organizations, these computerized attendance tracking and reporting systems have been broadly adopted in many locations and environments.

While the ability to accurately track and report attendance related data is highly desirable, and often vital, there are some issues associated with the adoption and implementation of computerized attendance tracking and reporting systems. For example, many organizations do not have the optimal number of staff and/or equipment necessary to effectively and efficiently track and report attendance for the number of attendees at a location, event or function, including the workplace or school. This may lead to inaccuracies or gaps in the attendance data.

Additionally, given the wide variety of desired reports and data analysis that may be required by disparate organizations, it is difficult for many organizations to find a standard attendance tracking and reporting solution that meets their specific needs, leading them to accept a less than satisfactory solution. Finally, from a budgetary perspective, the costs associated with implementing attendance tracking and reporting systems can be daunting for many organizations, particularly schools and non-profit organizations. However, since attendance tracking and reporting is vital to so many operations, it is rarely an optional activity. Accordingly, without improvements in the current systems, procedures, and methods for attendance tracking and reporting services, the overall process and user experience will continue to be sub-optimal.

### BRIEF SUMMARY OF THE INVENTION

The various implementations of the present invention are provided as a network computer system configured to allow for the tracking and reporting of user-specified events, including but not limited to, performance metrics and attendance data. This network computer system provides a user interface that allows a user to create metrics to be monitored, view and update event-related information, and to configure and review various pre-programmed and ad hoc reports so the users can monitor and evaluate performance metrics over time. Further, a wide variety of user and system generated alerts and messages or message events can be configured, allowing for automated and manual messaging related to the attendance or performance metrics that are being monitored. Alerts can be provided via email, non-electronic mail, telephone, SMS, facsimile, social networking sites and services (such as “tweets”), etc. In at least one implementation of the present invention, a computer-implemented method of tracking and reporting student performance and attendance-related events for an educational environment is provided.

### BRIEF DESCRIPTION OF THE FIGURES

The various preferred embodiments of the present invention will hereinafter be described in conjunction with the appended drawings, wherein like designations denote like elements, and:

FIG. 1 is a perspective view of a network computer system for providing tracking and messaging services in accordance with a preferred exemplary embodiment of the present invention;

FIG. 2 is a block diagram of a server used for implementing a network computer system for providing tracking and messaging services in accordance with a preferred exemplary embodiment of the present invention;

FIG. 3 is a block diagram illustrating the components of a network computer system for providing tracking and messaging services in accordance with a preferred exemplary embodiment of the present invention;

FIG. 4 is a flow chart of a method for providing tracking and messaging services in accordance with a preferred exemplary embodiment of the present invention;

FIG. 5 is a flow chart for a method used to create a watch list for use with a network computer system for providing tracking and messaging services in accordance with a preferred exemplary embodiment of the present invention;

FIG. 6 is a schematic diagram illustrating the effect of using an effective date in conjunction with a watch list used in a network computer system for providing tracking and messaging services in accordance with a preferred exemplary embodiment of the present invention;

FIG. 7 is a flow chart of a method used to create a policy for a watch list for use with a network computer system for providing tracking and messaging services in accordance with a preferred exemplary embodiment of the present invention;

FIG. 8 is a schematic diagram of a user interface for creating a watch list for use with a network computer system for providing tracking and messaging services in accordance with a preferred exemplary embodiment of the present invention; and

FIG. 9 is a graphical representation generated by an events tracker that tracks attendance over time with related events in accordance with a preferred exemplary embodiment of the present invention. As defined herein an “events tracker” is a software mechanism for tracking events and for displaying events using a charting mechanism.

### DETAILED DESCRIPTION OF THE INVENTION

The various implementations of the present invention are provided as a network computer system configured to allow for the tracking and reporting of user-specified events, including but not limited to, performance metrics and attendance data. This network computer system provides a user interface that allows a user to create metrics to be monitored, to view and update event-related information, and to configure and review various pre-programmed and ad hoc reports so the users can monitor and evaluate performance metrics over time. Further, a wide variety of user and system generated communications (e.g. alerts and messages or message events) can be configured, allowing for automated and manual messaging related to the attendance or performance metrics that are being monitored. As used herein “event” refers to any occurrence that may be represented as a data point and tracked by network computer system. In most preferred embodiments, the data for an event will include the date or time of the event, and the individual or individuals involved in the event (e.g. John was absent on Tuesday, or Susan was present on Wednesday, or emails were sent to 20 people on Thursday at 3 PM). As used herein, a “message event” is an event during which a message or messages are sent, and “message” refers to any discrete communication from network computer system to an intended recipient such as a student, parent, teacher, administrator, manager, worker, etc. Messages may be provided via email, non-electronic mail, telephone, SMS, facsimile, social networking sites and services (such as “tweets”), and other messaging mechanisms known to those skilled in the art, whether currently known or developed in the future. In at least one implementation of the present invention, a computer-implemented method of tracking and reporting student performance and attendance-related events for an educational environment is provided.

The various preferred embodiments of the present invention are specifically designed to provide a user-configurable platform for monitoring and tracking user-determined events and occurrences as well as the associated ability to generate message events to send messages to a wide variety of users, via multiple communication methodologies. The messages are any form of communication and may include communications such as updates, alerts, warnings, surveys, etc.

Aspects of the event tracking and reporting system are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Additionally, various preferred embodiments of the program product may be configured to: create and modify multiple databases; track, update and store data relative to event tracking and reporting; configure and implement various search and retrieve functions for a plurality of search requests and determinations made by users of the system; track and store information about various services and fees; update and transmit search results to one or more users; and provide one or more user interfaces for accomplishing all of these functions. Various preferred embodiments may also include a plurality of structures that are disclosed herein in singular form, or a single structure disclosed herein as a plurality; those skilled in the art will recognize when this may be effective for some embodiments.

In this fashion, the appropriate entities (i.e., administrators, managers, teachers, parents, students, etc.) can utilize the program product to initiate and complete a wide variety of database-related applications for the provision of event tracking and reporting services. Similarly, a program product in accordance with one or more preferred embodiments of the present invention can also be configured to perform substantially all of the steps depicted and described in conjunction with the figures below for implementing an event monitoring, tracking, and reporting system as described herein.

While the present invention will be described in detail by using various examples of a typical educational environment, those skilled in the art will recognize that the equipment, processes, methods and techniques described herein have broad applicability to other environments and applications where quick and efficient access to event tracking and reporting services is desirable, such as but limited to emergency notification, a workplace, and a healthcare facility.

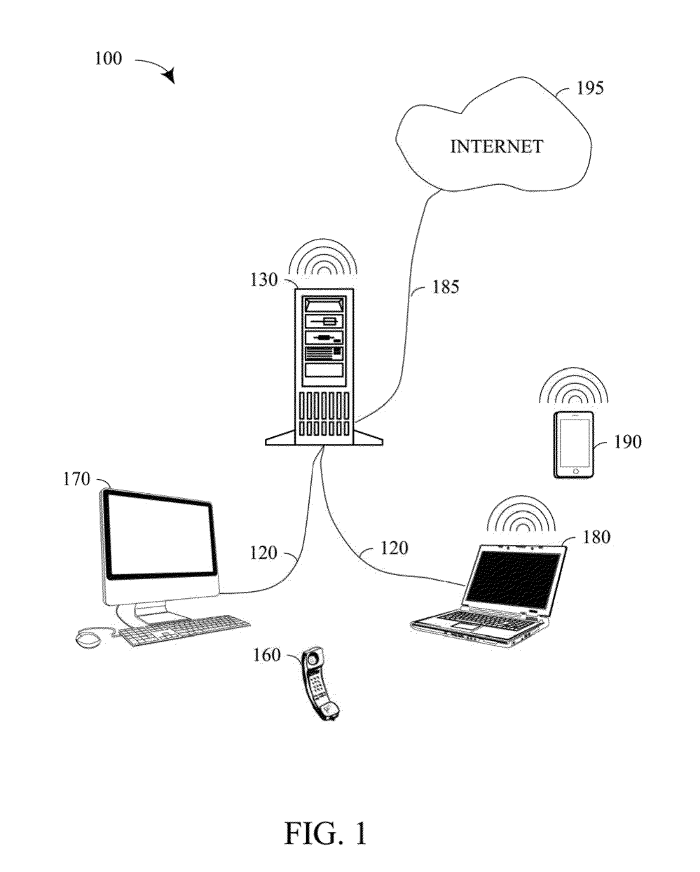

Referring now to FIG. 1, a network computer system 100 for providing tracking and messaging services in accordance with a first preferred exemplary embodiment of the present invention comprises: a data server 130; at least one of a desktop computer 170, a laptop computer 180, a telephone 160, and a smartphone or Personal Digital Assistant 190 all connected or coupled via a network or networks 120 to the Internet 195 via an Internet connection 185.

Taken together, the components of network computer system 100 provide a platform for reporting and monitoring the occurrence of events, and also provide a facility for related tracking and messaging services. In some embodiments, the data server 130 receives information about events directly from the computer 170, laptop computer 180, telephone 160 or smartphone 190; in other embodiments, data server 130 receives information about events from a separate database, such as a student information system (SIS) database, which may reside on a different data server (not shown this FIG.).

Data may be transferred from a separate database by any means including text file transfers, connection over network 120 to the database itself, connection via Schools Interoperability Framework (SIF), connection to a third party, or any means known to those skilled in the art, whether currently known or developed in the future. Network computer system 100 provides a mechanism for a group of users to efficiently and effectively track, store, monitor, and report the occurrence of various events and the results of events as well as make decisions and take actions based upon the occurrence of the events.

In the most preferred embodiments of the present invention, network computer system 100 is configured as a system that will be used to track and monitor certain aspects of student behavior and performance, including required attendance, in a typical school environment. In this preferred embodiment, the group of users for network computer system 100 will typically include administrators for individual schools as well as school board and school district officials. Further, depending on the specific preferences of the administrators, limited access to various features and functions of network computer system 100 may be provided to teachers, parents, and students.

Network 120 represents any suitable computer communication link or similar communication mechanism, including some combination of a hardwired connection, an internal or external bus, a connection for telephone access via a modem, a standard co-axial cable line, a high-speed T1 line, radio, infrared or other wireless communication methodologies (i.e. “Bluetooth,” infrared (IR), etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard Internet connection 185 between the various components of network computer system 100 for providing access to additional network resources and other remote locations. Network 120 provides for communication between the various components of network computer system 100 and allows for relevant information to be transmitted from device to device. In this fashion, a user of network computer system 100 can quickly and easily gain access to the relevant data and information utilized to search, retrieve, and display information from one or more databases as described in conjunction with the preferred embodiments of the present invention.

In the most preferred embodiments of the present invention, network 120 is configured to provide relatively high-speed transmission of both audio and video data and signals and comprises at least an Internet connection 185 for transmission of data captured by one or more computers 170 or 180 and a phone connection for transmission of an audio signal to and from a standard phone 160. The phone connection may be interfaced to a standard phone system typically found in most homes and commercial facilities, including for example, the existing “land line” phone system infrastructure and/or digital cellular phone communication systems.

In addition to the other components shown in FIG. 1, a wireless communication access device may be communicatively coupled to network 120 and may be any wireless communication mechanism that is known to those skilled in the art to provide for wireless communication between network 120 and the various devices associated with network 120, including desktop computer 170, laptop computer 180, phone 160, and smart phone 190. The most preferred embodiments of an acceptable wireless communication access device may comprise any type of wireless bridge, wireless router, or similar type of device (not shown this FIG.).

Regardless of the specific components, physical nature, and topology, network 120 serves to logically and communicatively link the physical components of network computer system 100, thereby enabling stable and consistent communication between the components. This is especially important because in many preferred embodiments of the present invention, data server 130, desktop computer 170, and laptop computer 180 may be geographically remote and/or physically separated from each other.

Data server 130 represents a relatively powerful computer system that is made available to desktop computer 170, laptop computer 180, phone 160 and/or phone 190 via network 120. Each of these components (desktop computer 170, laptop computer 180, phone 160 and/or smartphone 190) can send information to data server 130 or receive information from data server 130. Not shown in FIG. 1 are other components that may be connected to data server 130 via network 120, including other components which may both send and receive data, and components that can only receive information from data server 130, such as printers and facsimile machines. Various hardware components (not shown this FIG.) such as external monitors, keyboards, mice, tablets, hard disk drives, recordable CD-ROM/DVD drives, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art.

Given the relative advances in the state-of-the-art computer systems available today, it is anticipated that functions of data server 130 may be provided by many standard, readily available data servers. This may also include the deployment of multiple inter-connected and/or redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with network computer system 100 as described herein. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, desktop computer 170 is linked (via wired or wireless connection) to its own LAN, a WAN, or the Internet 195 and has access to one or more additional data servers (not shown this FIG.).

In addition as shown in FIG. 1, a telephone 160 may be used in conjunction with computer 170 and/or data server 130 to allow audio messages and alerts to be communicated to audio devices. In this application, telephone 160 has been communicatively coupled to or otherwise interfaced with the standard telephone communication infrastructure associated with one or more users of network computer system 100. Similarly, audio, video, and text messages and alerts may be communicated to or from smartphone 190.

Similarly, laptop computer 180 may be any type of relatively lightweight portable computer system known to those skilled in the art that is capable of being configured for use with network computer system 100 as described herein. This includes tablet computers (e.g., iPad®), pen-based computers and the like. Computer 180 may also be configured to send and/or receive audio, video and text signals, messages, and alerts via server 130 and network 120. Each of desktop computer 170 and laptop computer 180 may also be consider a user workstation for accessing and manipulating the data stored and processed in conjunction with server 130.

Additionally, netbooks, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN, a WAN, or Internet 195 and has access to its own data server (not shown this FIG.).

In general, the communication between devices associated with data server 130 will be data associated with tracking, monitoring and reporting information regarding certain events. The users of desktop computer 170 and/or laptop computer 180 may be program administrators, managers, teachers, parents and students who are seeking to provide or evaluate the performance and attendance events for a group of students. Additionally, various related entities such as school boards and school districts, and their employers and agents may also have access to one or more databases located on data server 130 via desktop computer 170 and/or laptop computer 180.

It should be noted that while FIG. 1 shows only a single desktop computer 170 and a single laptop computer 180, it is anticipated that the most preferred embodiments of the present invention will comprise dozens or even hundreds or millions of computers 170 and laptop computers 180, with various users accessing network computer system 100 via these user workstations. Each of these computers 170 and 180 will be configured to access data server 130 in an appropriately secure way so as to accomplish the specific objectives of the user of the desktop computer 170 or laptop computer 180.

For example, the service provider that controls the databases stored on data server 130 may utilize desktop computer 170 or laptop computer 180 as user workstations to access data server 130 and create, update or otherwise modify a given database. An operator, located in a remote location, may use desktop computer 170 or laptop computer 180 to access data server 130 to retrieve information about the persons and events being tracked by the users of network computer system 100.

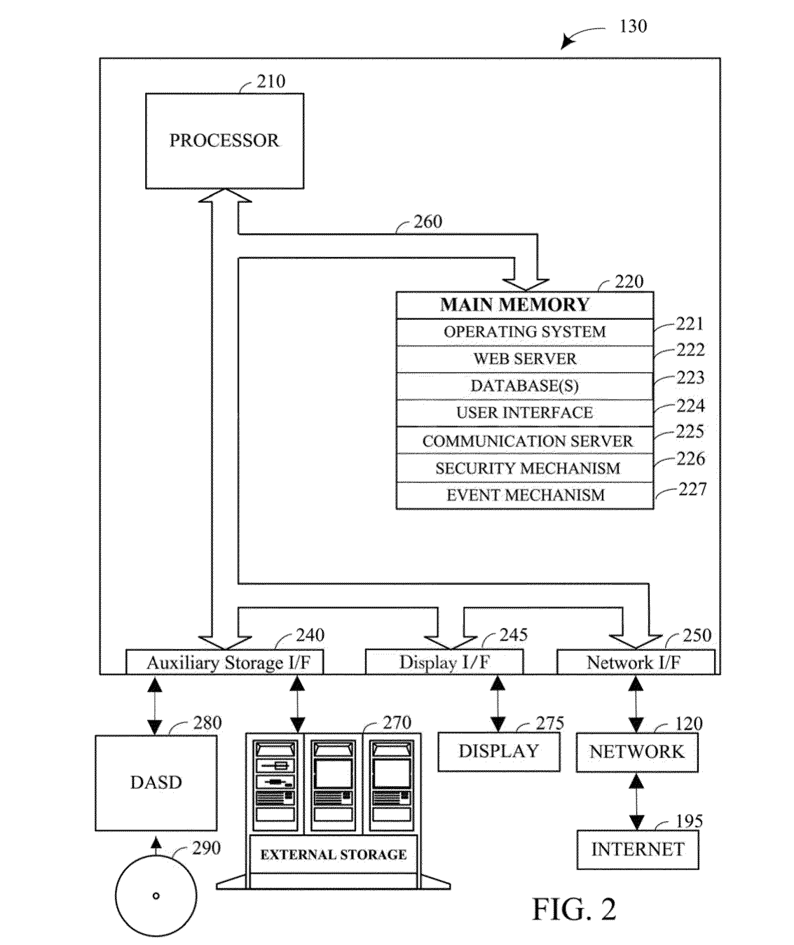

In the most preferred embodiments of the present invention, multiple desktop computers 170 and multiple laptop computers 180 will all be configured to communicate simultaneously with data server 130 and with each other via network 120. In addition, the most preferred embodiments of the present invention include an Application Service Provider (ASP) environment where data server 130 may be operated in a hosted environment. In this fashion, multiple desktop computers 170 and laptop computers 180 will have access to data server 130 and the databases stored thereon via a global computer network such as Internet 195. Data server 130 is further described below in conjunction with FIG. 2 below.

An optional printer and an optional fax machine (not shown this FIG.) may also be deployed for various hard copy data output requirements and may be considered to be any standard peripheral devices used for transmitting or outputting paper-based documents, notes, transaction details, reports, etc. in conjunction with the various requests and transactions processed by network computer system 100 (e.g., reports, statistical analyses, automated letters, etc.) Finally, it should be noted that the optional printer and the optional fax machine are merely representative of the many types of peripherals that may be utilized in conjunction with network computer system 100. It is anticipated that other similar peripheral devices will be deployed in the various preferred embodiment of the present invention and no such device is excluded by its omission in FIG. 1.

Smartphone 190 is representative of any type of cellular device or telephone that may be communicatively coupled to network computer system 100. This includes, for example, personal digital assistants (“PDAs”), Windows® mobile phone devices, Palm® OS devices, Pocket PC® devices, the Apple® iPhone® and other various types of smartphones. Those skilled in the art will recognize these various devices and others that are suitable for deployment as phone 190. While somewhat less powerful than computers 170 and 180, smartphone 190 may also be configured to wirelessly communicate with data server 130 via network 120 to send and retrieve tracking and messaging services related information to and from data server 130.

Given the standard functionality for devices that may be deployed as phone 190, this communication be provided by a wireless Internet connection 185 (e.g. “wi-fi” or “wi-max”) or a Bluetooth® connection. One example of the use for smartphone or PDA 190 in the context of network computer system 100 would be to send messages or alerts to a parent of a student, alerting the parent of important information regarding their student's performance or attendance.

Those skilled in the art will recognize that FIG. 1 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of network computer system 100. In some preferred embodiments of the present invention, this minimization is accomplished as data server 130 receives and aggregates information about events directly from desktop computer 170, laptop computer 180, telephone 160 or smartphone 190. In most preferred embodiments, this minimization is accomplished as data server 130 receives information about events by connecting to a database or file on a different data server (not shown FIG. 1), such as a student information system (SIS) database housed on a different data server.

Referring now to FIG. 2, data server 130 of FIG. 1 in accordance with a preferred embodiment of the present invention represents one of many commercially available computer systems such as a Linux®-based computer system, an IBM® compatible computer system, or a Macintosh® computer system. However, those skilled in the art will appreciate that the methods and system of the present invention apply equally to any computer system, regardless of the specific operating system and regardless of whether the computer system is a more traditional “mainframe” computer, a complicated multi-user computing device or a single user device such as a personal computer or workstation.

Data server 130 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disc 290.

Display interface 245 is used to directly connect one or more displays 275 to data server 130. Display 275, which may be non-intelligent (e.g., “dumb”) terminals or fully programmable workstations, are used to provide system administrators and users the ability to communicate with data server 130. Note, however, that while display interface 245 is provided to support communication with one or more displays 275, computer data server 130 does not necessarily require a display 275, because all needed interaction with users and other processes may occur via network 120. Additionally, in certain preferred embodiments, data server 130 may have an integrated display 275.

Network interface 250 is used to connect data server 130 to network 120 and network computer system 100, including computer 170 and computer 180 of FIG. 1. Network interface 250 broadly represents any suitable way to interconnect electronic devices, regardless of whether network 120 comprises present day analog and/or digital techniques or some networking mechanism of the future. Network interface 250 preferably includes a combination of hardware and software that allows communications on network 120.

Software provided in conjunction with network interface 250 preferably includes a communication manager that manages communication with other computer systems or other network devices via network 120 using a suitable network protocol. Many different network protocols can be used to implement network 120. These protocols are specialized computer programs that allow computers to communicate across a network 120. TCP/IP (Transmission Control Protocol/Internet Protocol) is just one example of a suitable network protocol that may be used by the communication manager contained within network interface 250.

It is important to note that while the present invention has been (and will continue to be) described in the context of a fully functional computer system with certain application software, those skilled in the art will appreciate that the various software mechanisms of the present invention are capable of being distributed as a program product in conjunction with an article of manufacture comprising a software application stored on a computer readable storage medium in a variety of forms, and that the various preferred embodiments of the present invention applies equally regardless of the particular type or storage medium used to actually carry out the distribution. Examples of computer readable storage media include: recordable type media such as DVD and CD-ROM discs (e.g., disc 290), and transmission type media such as digital and analog communication links, including wireless communication links.

Main memory 220 suitably contains an operating system 221, a web server 222, one or more databases 223, a user interface 224, a communication server 225, a security mechanism 226, and an event mechanism 227. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual software mechanisms or components shown in main memory 220 might be combined in various forms and distributed as a stand-alone program product. Finally, it should be noted that additional software components, not shown in this figure, might also be included.

Operating system 221 includes the software that is used to operate and control data server 130. In general, processor 210 typically executes operating system 221. Operating system 221 may be a single program or, alternatively, a collection of multiple programs that act in concert to perform the functions of operating system 221. Any operating system now known to those skilled in the art or later developed may be considered for inclusion with the various preferred embodiments of the present invention.

Web server 222 may be any web server application currently known or later developed for communicating with web clients over a network such as Internet 195. Examples of suitable web servers 222 include Apache® web servers, IIS web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, web server 222 provides access, including a user interface, to allow individuals and entities to interact with user interface 224, including via network 120 of FIG. 1.

Database 223 is representative of any suitable database known to those skilled in the art. Database 223 may store records of (i.e. relating to) events and individuals, including related persons. As used herein, “individual” and “individuals” refers to entities, such as people or corporations, which are recorded in the database. Also, if a message is about a first individual, then a “related person” as used herein is not necessarily a family relation, but is a second individual who is societally related or connected in some way to the first individual, such as a parent, guardian, teacher, or employer, so an intended recipient of a message may be the individual the message is about, or it may be a “related person” relating to that individual.

In most preferred embodiments of the present invention, the database 223 stores information about individuals such as addresses or photographs, and it also stores information about events relating to the individuals. In the most preferred embodiments of the present invention, database 223 is a Structured Query Language (SQL) compatible database file capable of storing information relative to various items that may be of interest to the users of network computer system 100 of FIG. 1. In the most preferred embodiments of the present invention, database 223 will comprise a plurality of information that may be useful to an organization or individual that wants to perform event tracking and reporting activities in conjunction with a preferred embodiment of network computer system 100 of FIG. 1.

User interface 224 is a software component that provides the users of network computer system 100 of FIG. 1 a means for interacting with the various components of network computer system 100. In the most preferred embodiments of the present invention, user interface 224 includes a web browser based graphical user interface, accessible to the users of network computer system 100 via any standard web browser from any computer that is connected to Internet 195 of FIG. 1. User interface 224 allows users of network computer system 100 to transmit data, such as messages, alerts, responses, and/or commands, to components of network computer system 100 and/or to receive data (such as messages and/or charts) from components of network computer system 100. Accordingly, in some embodiments user interface 224 may include phone based interfaces, smartphone “mobile app” interfaces, email interfaces, and/or interfaces that only receive data such as printer or facsimile based interfaces. Those skilled in the art will understand that many variations of user interface 224 are possible. Additional details on user interface 224 are presented below.

In a preferred embodiment of the present invention adapted for tracking performance and attendance in an educational environment, database 223 will typically include a plurality of database records containing information about multiple schools and students (e.g., location, student names, grades, dates and times of attendance, etc.) as well as information about teachers and parents (e.g., names and addresses, contact information, etc.), and specific situation/circumstances for various performance and event applications (e.g., criteria for identifying areas of concern for a student or group of students) as well as information providing for tracking, analyzing and reporting information that may be used to provide various services to the prospective users of network computer system 100 of FIG. 1.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 may also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

The most preferred embodiments of network computer system 100 of FIG. 1 will typically include a communication server 225 in main memory 220. Communication server 225 is an automated programmable system that is capable of generating one or more forms of messages or message events. For example, communication server 225 may be configured to send automated email messages or SMS messages to cell phones. Communication server 225 may also be used to generate hard copy messages (e.g., mail merge letters) that are then sent via standard U.S. Postal Service or some type of commercial message delivery company.

Additionally, communication server 225 may be configured to generate a facsimile message by utilizing a fax server and a facsimile modem (not shown this FIG.) that is contained in data server 130 of FIG. 2. Communication server 225 is also capable of being configured and used to send and receive various electronic status messages (e.g. audio and video alerts) and updates to data server 130 and between computers 170, 180, and/or smartphone 190 of FIG. 1, as may be necessary to enhance the overall process of completing activities related to the provision of event tracking and reporting services as described herein.

This includes the generation of automated email messages relating to the tracking and reporting of performance and events as well as sending informational messages related to students, etc. Automated or on-demand e-mail messages are also generated to provide event related notifications (e.g., messages and other data related to and regarding the status of student attendance) as well as other information related to the programs and participants in accordance with the various preferred embodiments of the present invention.

In addition, most preferred embodiments of the present invention will include a security and/or encryption mechanism 226 for verifying access to the data and information contained in and transmitted to and from data server 130. Security mechanism 226 may be incorporated into operating system 221 and/or web server 222. Additionally, security mechanism 226 may also provide encryption capabilities for other components of network computer system 100 of FIG. 1, thereby enhancing the robustness of network computer system 100 of FIG. 1. Security mechanism 226 is most preferably configured to protect the integrity and security of the information transmitted via network 120 of FIG. 1. In most preferred embodiments security mechanism 226 defines permissions for users, which limit what each user can do based on that user's role (e.g. school district administrator, school principal, teacher, or parent).

Further, depending on the type and quantity of information stored in database 223 and accessed by user interface 224, security mechanism 226 may provide different levels of security and/or encryption for different computer systems 170 and 180 of FIG. 1 and the information stored in database 223. The level and type of security measures applied by security mechanism 226 may be determined by the identity of the end-user and/or the nature of a given request and/or response. In some preferred embodiments of the present invention, security mechanism 226 may be contained in or implemented in conjunction with certain hardware components (not shown this FIG.) such as hardware-based firewalls, switches, dongles, and the like.

In the most preferred embodiments of the present invention, the various components of network computer system 100 of FIG. 1 are able to communicate using multiple communications protocols and systems (e.g., Voice over IP or “VoIP”, Plain Old Telephone Service or “POTS”, etc.). Those skilled in the art will recognize that the communication protocols used herein may be readily adapted and configured to allow for the rapid and efficient transmission and receipt of data by and between the various components of network computer system 100 of FIG. 1. This would also include the ability to control and customize the input and output of network computer system 100 of FIG. 1 for integration with other systems. While a specific exemplary embodiment of a suitable server 130 has been provided above, those skilled in the art will recognize that many other suitable computers (with more or fewer features) may be substituted for the specific example provided herein without departing from the spirit and scope of the present invention.

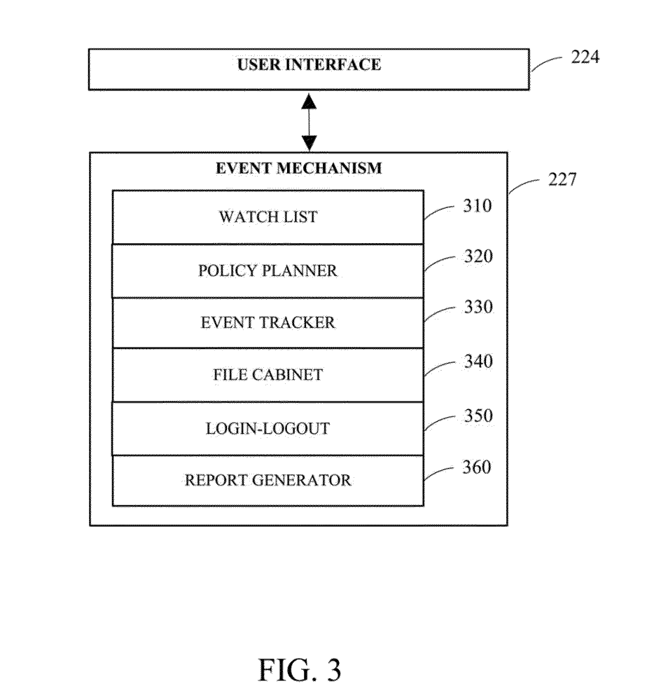

Referring now to FIG. 3, a block diagram of the various components of event mechanism 227 is presented. As shown in FIG. 3, user interface 224 provides a way for the users of network computer system 100 of FIG. 1 to interact with the various components of event mechanism 227. In the most preferred embodiments of the present invention, event mechanism 227 comprises: one or more watch lists 310; a policy planner 320; an event tracker 330; a file cabinet 340; a login-logout mechanism 350, and a report generator 360. The one or more watch lists 310; policy planner 320; event tracker 330; file cabinet 340; login-logout mechanism 350, and report generator 360 are each modules which are all used in the most preferred embodiments, but which may not all be present in all embodiments of the present invention and various applications may use different components, as necessary or desired.

A watch list 310 is a software mechanism that contains the identifying information for one or more individuals who meet a pre-determined “watch list criteria.” In the most preferred embodiments of the present invention, the watch list criteria is a profile for a specific performance measurement or event. An individual is placed on a watch list 310, (i.e. a reference to the individual is added to the list) if they meet the watch list criteria. Accordingly, a given watch list 310 will comprise references to each individual recorded in the database who meets the watch list criteria. For example, if a student has failed to attend school or certain classes for a pre-determined number of events, during a pre-determined time interval, that student can be automatically identified and placed on the appropriate watch list 310.

Similarly, if a student has fallen below a pre-determined threshold for academic performance, that student may be placed on a separate watch list 310. Accordingly, a given individual may be placed on multiple watch lists 310. Further, the watch list criteria can be for positive as well as negative performance and events. For example, another watch list 310 may be established for students that achieve perfect attendance over a period of time or for students who maintain a certain grade point average (GPA), for example. Depending on the specific watch list criteria, the nature and quantity of information recorded on a given watch list 310 may vary from the information recorded for another watch list 310.

For any given network computer system 100, multiple watch lists 310 can be created, each with its own specific watch list criteria for inclusion of watch list 310 members or subjects (e.g., the identification of a specific subset of individuals from a larger group of candidate individuals). In the most preferred embodiments of the present invention, each watch list 310 is identified with a unique identifier, so that multiple watch lists 310 may be clearly distinguished. Whenever a new individual or individuals are added to a watch list 310, they will typically be considered “unacknowledged” until a user intervenes to acknowledge the inclusion of the individual on the watch list 310. A watch list 310 may also optionally define one or more people to notify if individuals remain unacknowledged after a certain period of time. For example, an administrator who established a watch list 310 may choose to receive daily emails listing unacknowledged individuals on that watch list 310. The administrator is thereby notified of the addition of individuals to the watch 310 and the administrator may “acknowledge” their inclusion on the watch list 310.

In general, once an individual is placed on a watch list 310, they will generally remain on that watch list 310, since the reason for their inclusion on a watch list 310 is typically an historical fact. The user of network computer system 100 can view the individuals that have been placed on a watch list 310 and determine whether or not to send a message to one or more individuals that have been placed on that watch list 310. The user may also choose to personally contact one or more individuals that have been placed on that watch list 310.

In some preferred embodiments of the present invention, the user may also record actions taken based on the watch list 310 such as personal contacts, messages, or steps taken as part of an Individualized Education Program (IEP). In at least some preferred embodiments of the present invention, a watch list 310 is connected to communication server 225 of FIG. 1, providing users with a “watch list sending mechanism,” which is a software mechanism that allows the user to send one or more messages manually to individuals placed on that watch list 310, or to related persons. In other preferred embodiments, messages are sent automatically by communication server 225 of FIG. 1, based on a policy threshold criteria that is also used to generate a watch list 310, so that users may choose how to best follow up with the recipients of automatically sent messages. The user can, if appropriate permissions have been granted, be allowed to “hide” an individual on the watch list 310. The hidden individual will remain on the watch list 310 but will not appear in the visual listing or display of the watch list 310. Similarly, with appropriate system level permissions, an individual may be removed from a watch list 310.

In most preferred embodiments of the present invention, a watch list 310 is customizable to meet the needs of the user of network computer system 100. For example, a watch list 310 may include information about itself, such as a title and/or description. It may also be based on a customizable watch list criteria: for example, in the attendance context, the user may choose what type of attendance events to monitor on that watch list 310 (e.g, absences or tardies, whether an absence refers to missing a single school period or an entire day, etc.) The user may, in some embodiments, use a watch list criteria based on a combination of factors such as attendance and grades.

For example, a watch list 310 may report individuals with over 20 absences and D grades. The user also chooses the date from which the watch list 310 will count attendance events; this date may be on or after than the date when network computer system 100 began tracking attendance events. The user may base watch list criteria for students on the number of absences since the beginning of the school term, the number of absences in a particular number of recent school days (such as 5 absences in the last 10 days), or a certain number or more of consecutive absences. Those skilled in the art will recognize that this is an exemplary embodiment and that a watch list 310 may include subjects based on many types of customizable watch list criteria.

Policy planner 320 is a software mechanism that is accessed by a user via user interface 224 and that is communicatively coupled to communications server 225 to automatically send messages based on one or more policies. Policy planner 320 also captures the criteria for sending messages, and the number of messages sent based on one or more policies. A policy is a software mechanism that sends messages when a threshold algorithm determines that an associated threshold criteria, which is specific to the policy (e.g. number of occurrences of a specific event), is met, exceeded, or violated. This allows for the creation of a message event or series of message events (e.g., message events that send an email message, send an SMS message, make an automated phone call, send a facsimile message, etc.) that will be triggered whenever the threshold criteria is violated, as determined by the threshold algorithm. A user can access policy planner 320 via user interface 224 and create and modify various policies, as necessary or desired. This allows the user to model various policies, as well as the effects of various policies are they are modified by the user.

Messages are sent to the individuals who violate the threshold criteria, or to related persons (e.g, the individual's supervisor, manager, teacher, parent, guardian, etc.). Although the policy provides for automatic triggering of message events, most preferred embodiments also allow manual generation of one or more message events. In most preferred embodiments, policy planner 320 and event tracker 330 may both also use a “charting mechanism” that is configured to automatically display policy effects in connection with user interface 224 and report generator 360. As used herein, “policy effects” refers to any data that is, may be, or is intended to be affected by a policy, and the charting mechanism may display policy effects by any method that automatically presents the data to a user of network computer system 100, such as a chart on a computer display, in an email message, or in a printed message, or a report in a phone call.

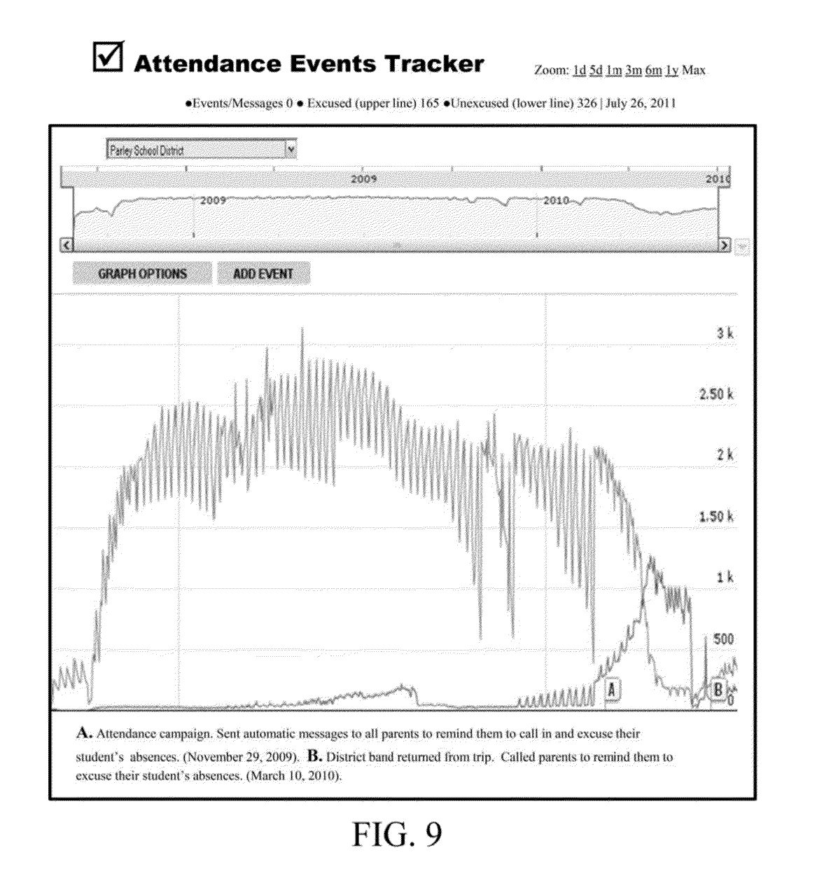

If a policy is configured to generate messages based on attendance, policy effects could include data about any attendance events. Policy effects can include direct results of the policy such as the number of automatic phone calls made, and intended or even indirect results of the policy such as improvements in school attendance over time. In some embodiments, the charting mechanism may automatically display a table chart of the number of calls made each day of the week, or a timeline chart of school attendance before and after the policy was implemented (FIG. 9).

The threshold algorithm is provided to determine if a given set of events that occurred during the relevant timeframe violates the threshold criteria associated with the policy, and the identity of the individuals, if any, that are associated with that set of events. Further, in most preferred embodiments, the policy will send messages only if the threshold algorithm determines that the threshold criteria is violated by events that occurred within an effective time frame, which is generally a subset of a larger time frame.

One important feature provided by the most preferred embodiments of the present invention is the use of an “effective date range” in conjunction with a policy. When using an effective date range, in a situation where attendance is to be monitored and reported, the user can generate message events for selected students who have violated the threshold criteria during the effective date range. The “date range” is the time period in which all events (e.g., absences or tardies) are to be monitored. The date range includes a “start date” which date corresponds to the first calendar date from which the policy counts or monitors events, and an “end date”, which may be the current date or another date but which date refers to the last date that will be considered by the policy for the specified event or events (“current date,” as used herein, refers to the actual date on which a policy is used to evaluate the and may be the date on which the event messages are generated and sent).

The start date for a policy is the date from which policy begins counting or monitoring events, and may be different from the date on which network computer system 100 began monitoring events. The effective date range is the period during which one or more of the events must have violated the threshold criteria. The effective date range begins on or after the start date, and ends on or before the current date. For the most preferred embodiments of the present invention, the message events will be generated only for those students who have violated the threshold criteria during the effective date range.

A threshold criteria is a representation of the event or events that should trigger the policy to send messages. In most preferred embodiments, the threshold criteria may be represented as a list or range of numbers, and a type of events to count, such as absences, tardies, or absences plus tardies. The numbers in the list represent the number of occurrences of the specified event necessary to violate the threshold criteria. For example, the threshold criteria could be [4, 5, 6 absences], meaning that the threshold criteria includes a student's fourth, fifth, or sixth absence. In these embodiments, the number of events that occurred during the effective date range may also be represented as a list of numbers. For example, the absences list could be [5, 6, 7], meaning that the student's fifth, sixth and seventh absences occurred during the effective date range.

A threshold algorithm is what defines and determines if a corresponding threshold criteria is violated. At least two threshold algorithms may be used, in at least some preferred embodiments, to determine if the threshold criteria is violated. In the “anytime” algorithm, the threshold criteria is violated if there is any intersection between the threshold criteria and the list of events that occurred during the effective date range (i.e. the lists share at least one element). So, if the threshold is [4, 5, 6 absences] and the absences list is [5, 6, 7], the threshold criteria is violated because both lists have 5 and 6 in common.

In the “end” algorithm, the threshold criteria is violated if the last event in the list of events that occurred during the effective date range is also an element of the threshold criteria. In this case, if the threshold is [4, 5, 6 tardies] and the tardies list is [5, 6, 7], the threshold criteria is not violated because the last tardy during the effective date range was the seventh, and 7 is not in the list representing the threshold criteria. Schools might use the “anytime” algorithm if they want to send a message at any point in time that the fifth absence happened during the effective date range. They might use the “end” algorithm if they want to send a message if the fifth absence, but not the sixth, happened during the effective date range. This might be desirable if, for example, a different policy sent a more urgent message after the sixth absence.

In other embodiments of the present invention, a threshold criteria may be represented in other ways, besides as a list of numbers and a type of events to count. For example, a threshold criteria can be represented as one or two numbers representing upper and/or lower bounds, so that messages will be sent when a monitored event falls outside those bounds. For example, the upper and lower bounds could represent a student's cafeteria balance, or money owed, so that messages could be sent when the account was low and needed to be replenished, or when it was unexpectedly high.

Similarly, a lower bound could be used to represent grades, so that a warning message is sent when a student's grades drop below the threshold criteria. An upper bound could also be used to represent grades so that a congratulatory message is sent to honor roll students. in some embodiments, the user can specify that whether a message is for good or bad grades so that network computer system 100 can automatically determine whether the threshold criteria is intended to be an upper or lower bound. Threshold criteria can also be represented as a different type of list such as a list of letter grades.

In that case, the threshold criteria is violated when a student's letter grade appears in the list. In some embodiments, violating the threshold criteria is not a negative event. For example, if the threshold criteria is a list [A,B] representing grades so that letters are sent to students with good grades, an A grade violates the threshold criteria, but is a positive event. Although the following examples use a threshold criteria which is a list or range of numbers and a type of events to count, those skilled in the art will recognize that any type of threshold criteria, combined with a threshold algorithm that clearly defines when the threshold criteria is violated may be used.

Most preferred embodiments of the present invention apply the threshold criteria in conjunction with a start date and an effective date range in multiple different ways. For example, messages can be sent based on the number of absences since a particular date, the number of absences in a particular number of recent days (e.g. if a student has 5 absences in the last 10 days), and/or a certain number of consecutive absences.

In one example, a school may elect to make calls each day to the parents or guardians of students who accumulated their fifth absence that day by using a date range where the start date is the beginning of the school term and the end date is the current date, an effective date range that begins and ends on the current date each day, and a threshold criteria of [5 absences]. Or, a school may elect to make calls once a week for students who were absent that week by using an effective date range that runs from the beginning of the week to the end of the week. In this case, using an effective date range ensures that duplicate calls are not sent in subsequent weeks because even though the student still has 5 absences, he or she will not have had 5 absences during the effective date range (the most current day or week).

In another example, a school may elect to send emails to students (or their parents or guardians) who have 5 absences in the last 10 days (from 9 days ago until the current date). In this case, it is only necessary to count absences for the last 10 days, so the date range start date is 9 days ago and the end date is the current date. Emails should be sent if the fifth absence occurs any time in the last 10 days, so the effective date range is the same as the date range, and the threshold is [5 absences]. The “anytime” algorithm is used to send messages to all students who had their fifth absence in the effective date range, but the “end” algorithm could be used if the school wished to send emails only to students who had exactly 5 absences in the last 10 days—for example if a different policy called students' parents on the sixth absence.

In another example, a school may elect to send an email to a student's parents or guardians about a student's fifth consecutive absence. This uses the above method twice, to determine which students had 5 absences in the past 5 days, but did not have 6 absences in the past 6 days.

During an 18 day school period, the threshold criteria for a given policy could be, for example, the accumulation of 15-18 absences since a start date at the beginning of the school term (criteria=[15, 16, 17, 18 absences]). 18 days after the start date, if a student had been absent every day during the date range, then the subject would have violated the threshold criteria by accumulating 18 absences. If the effective date range is from day 16 to day 18, then network computer system 100 of FIG. 1 would determine that the student had also violated the threshold criteria during the effective date range.

In accordance with the pre-determined activities for that policy, network computer system 100 would then generate and send one or more automatic message events or messages to the appropriate parties, in accordance with the policy. If the effective date range was from day 11 to day 13, then the student would not have violated the threshold criteria during the effective date range, and network computer system 100 would not send automatic messages to the interested parties or related persons. The use of an effective date range allows network computer system 100 to work with more complex and more flexible threshold criteria.

Additionally, if network computer system 100 had been configured to send messages about the students who had accumulated 15 to 18 absences since the start of the school term, the start date of the date range is fixed at the start of the school term but the end date of the date range continues to move forward with the current date. If network computer system 100 determines whether to create message events each day, then network computer system 100 is configurable to generate and send messages on the dates of students' 15th through 18th absences, but not on subsequent days, to avoid sending redundant messages. If the effective date range is set each day to begin and end at the current date, then a message will be sent on the date of a student's 18th absence because the threshold criteria was violated during the effective date range. Messages will not be sent on subsequent days because as the effective date range moves forward, the student's 15th through 18th absences do not occur during the effective date range. So, while the threshold criteria remains violated, it is no longer violated during the effective date range.

By contrast, without incorporating the use of an effective date range, even if the student was not absent again for the remainder of the school year, the total number of absences accumulated by that student would continually remain at 18 absences, and network computer system 100 would continue to find that the student had violated the threshold criteria, so network computer system 100 would continue to generate and send messages to notify the designated parties that the student had accumulated 18 absences. The effective date range specifies the period during which an event occurs which violates the threshold criteria. A user may configure network computer system 100 so that network computer system 100 then creates and/or sends one or more messages either during or after the effective date range.

In another example of using the effective date range, if messages are only sent every three days, the current date could be day 19 and the effective date range could be day 16 to day 18. If the absences accumulated by the student during the effective date range violate the threshold criteria, then, in accordance with the directives associated with that policy, network computer system 100 would generate one or more messages for that student.

Three days later, on day 22, the effective date range could be moved to day 19 through day 21. If network computer system 100 consistently shifts the effective date range in this manner as time passes, then network computer system 100 can avoid generating and sending duplicate messages for the same student for the same violation.

In most preferred embodiments of the present invention, network computer system 100 shifts the effective date range so that there is no overlap between consecutive effective date ranges. For example, on day 19, the effective date range is day 10 to day 14. By querying the database 223 on day 19, network computer system 100 allows parents or guardians of the students to excuse absences before network computer system 100 queries the database 223 and determines which students have violated the threshold criteria. Then, on day 24, network computer system 100 determines which students have violated the threshold criteria during an effective date range of day 15 to day 19. Alternatively, on day 19, the effective date range is day 14 to day 18 so that guardians have one day to excuse absences and then on day 24 the effective range could be from day 19 to day 23.

In yet another preferred embodiment of the present invention, on day 19 network computer system 100 determines which students have violated the threshold criteria by using an effective date range of day 15 to 19. In this embodiment, since network computer system 100 determines on the last day of the effective date range which students have violated the threshold criteria, then unless the parent or guardian of students notify the school by the last day of the effective date range and the school has updated the database 223 by the time that network computer system 100 calculates which students have violated the threshold criteria, network computer system 100 calculations would not reflect the most accurate event data.

If, on day 19, a user wanted network computer system 100 to determine the number of absences that occurred during a period that began with day 1 and ended with day 18; and if the effective date range began on day 18 at 12:00 a.m. and ended on day 19 at 12:00 a.m.; and if a student had been absent every day from day 1 to day 18, then network computer system 100 would determine that the student had violated the criteria during the effective date range and network computer system 100 would send one or more messages as prescribed by that policy.

In certain preferred embodiments of the present invention, network computer system 100 may be configured to create one or more message events or messages based on a student's behavior and to then send or deliver the message on a later date, allowing for scheduling and delivery of messages in other than real time. In other preferred embodiments of the present invention, network computer system 100 creates a message for the related person of an individual and sends the message on the same date that the communication was created.

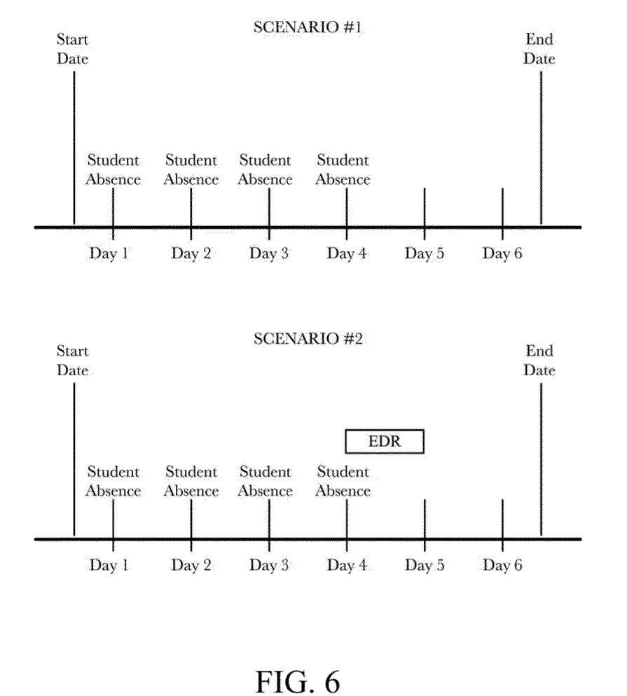

Referring now to FIG. 6, a diagram illustrating the use of a start date and an effective date range is depicted. Under scenario #1, a student has 4 consecutive absences and network computer system 100 has been configured to query database 223 each day and create relevant messages each day for any students that have exceeded the threshold for allowed absences. If the threshold criteria is set at 3 or 4 absences for a student since the start date, then for a date range of day 1 to day 6 inclusive, network computer system 100 would determine that student X had violated the threshold criteria and network computer system 100 would create and send one or more messages for student X. However, even if student X never accumulated another absence during the rest of the school year, the total number of absences for student X would remain at 4. So, even if network computer system 100 was configured to create and send messages using another interval than every day (e.g., once a week) for the students who violated the threshold criteria, whenever network computer system 100 queried the database 223 to determine which students had violated a threshold criteria of 3 or 4 absences, network computer system 100 would then determine that the student X had violated the threshold criteria and would create another round of messages.

The use of an effective date range, in addition to a date range, has some advantages, including the advantage of configuring network computer system 100 so that it only creates a single series of messages for a student that accumulates 3 or 4 absences. Under scenario #2, the date range is from day 1 to day 6 inclusive and the effective date range is from 12:00 AM on day 4 to 12:00 AM on day 5. Under the threshold algorithm, network computer system 100 is instructed to query the database 223 for student absences occurring since the start date that violate the threshold criteria and, if the user has instructed network computer system 100 to also use an effective date range during the query, then the threshold algorithm will also determine whether a student has accumulated an absence or absences that violate the threshold criteria during the effective date range. Accordingly, when the effective date range is day 4, a message is sent because the student's absence violates the threshold criteria during the effective date range. However, on subsequent days, the effective date range is moved forward, and no duplicate messages are sent, because the student's third or fourth absence are no longer within the effective date range.

Under scenario #2, network computer system 100 would send a message only on day 4 because of the requirement that student X accumulate an absence that violates the threshold criteria during the effective date range. Thus, network computer system 100 would only send a message on day 4.

In the most preferred embodiments of the present invention, as each policy is created, a unique identifier for that policy is also created and associated with that policy. The unique identifier is embedded in the data for the message events that are generated by communication server 225 of network computer system 100. This allows the policy to be identified and associated with each message that is sent based on that policy, and optionally associated with the individuals to whom those messages were sent.

Additionally, in most preferred embodiments of the present invention, policy planner 320 in conjunction with the user interface 224 and report generator 360, uses a charting mechanism to automatically display a table chart summarizing policy effects such as the threshold criteria for each policy, the action taken (such as whether a letter, email, or other message is sent) when the threshold criteria for that policy was violated, and/or the number of messages sent based on that policy, either in total or for each day in a recent time period. Further, in most preferred embodiments, the user may select parts of this summary table chart to see more detailed information.

For example, if the table chart shows that 1000 messages were sent on Wednesday for a particular policy set up by a school district administrator, that administrator could select the number “1000” on the summary table chart to see how many messages were sent for each school that policy applies to. Further, that administrator could select each school's name to see delivery statistics (e.g. deliveries attempted, rate of delivery attempts, number delivered, etc.) for the batch of messages sent for that school based on that policy, or even to see the content of each message. This allows for rapid and efficient identification of effective policies, elimination of less effective policies, and creation of new, more effective policies.

In most preferred embodiments, policy planner 320 is used with policies implementing an effective date range where the user can choose the length of the effective date range, as well as the time between the end of the effective date range and the current date, for reasons such as allowing parents time to excuse absences before messages are sent. Other types of automatic messaging based on policies may be used, where the threshold criteria is violated only on the date a certain number of events is exceeded, so, for example, a school could automatically send a message on the date a student's fifth absence occurs.

This type of policy, which may be referred to herein as a “simple policy,” is equivalent to using an effective date range if the effective date range is identical to the current date (i.e., it begins and ends on the current date). Policy planner 320 may be used with any policy, including a simple policy that does not fully implement an effective date range as disclosed herein, in order to provide a user with access to information about the effects of the policy, such as the above-disclosed table chart which summarizes policy information and optionally provides access to more detailed information. Conversely, in some embodiments of the present invention, a policy may be used to send messages based on threshold criteria and implementing an effective date range, without the portion of the policy planner 320 mechanism that provides a user with access to information about the effects of that policy.

Event tracker 330 is a software mechanism provided to track event data such as attendance data or performance data, as well as the messages, statuses and responses generated and received by network computer system 100. Event tracker 330, via user interface 224, provides a user with aggregated and segregated data views, based on the event data, as well as the messages, statuses and responses generated and received by network computer system 100. In most preferred embodiments of the present invention, the charting mechanism can automatically display policy effects and/or other data on one or more timeline charts, including any event data points such as absences, the dates of automated and manual message events, as well as any associated message statuses (e.g. busy signal, email undeliverable, SMS message delivered) and associated responses to automated and manual message events.

In certain embodiments of the present invention, the timeline chart may include annotations about events such as the dates of a flu epidemic to explain low attendance, or the date a policy began, so that the school administrator implementing policies may observe a policy's effect on the trend of the event data, and form new, more effective policies. For example, a policy that calls parents every time a student is absent may result in a decrease in the number of absences shown in the timeline chart. In some embodiments, event tracker 330 may also perform statistical analysis of event data and display the data and the analysis results on a timeline chart to annotate statistically significant trends. A timeline chart may also include any other data that can be associated with a date, such as a student's grades or a cafeteria account balance over time.

Event tracker 330 may be used with any policy, including simple policies that do not fully implement an effective date range as disclosed herein, in order to provide a user with access to information about the effects of the policy, such as the above-disclosed timeline chart displaying related event data, message events, statuses, and/or responses. Conversely, in some embodiments, a policy may be used to send messages based on threshold criteria and implementing an effective date range, without the event tracker 330 mechanism that provides a user with access to information about the effects of that policy.

File cabinet 340 is a software mechanism provided in most preferred embodiments, accessed via user interface 224, that provides a repository or storage location for data associated with each individual whose information is stored by network computer system 100. This includes any data about the individual, which may include, but is not limited to: attendance data, performance data, grades, class schedules, an individual's photograph, student ID number, social security number, cafeteria account balance, address, phone number, email address, parents' information, relationship to other users (e.g. siblings), grade level, expected graduation year, current and past schools attended and schools that will be attended in the future, and the date and nature of each message, status and response as well as copies of any letters or messages that have been sent, along with any associated responses. By using user interface 224, a user of network computer system 100 of FIG. 1 can view a chronological timeline chart of the various messages, statuses, and responses, including messages that are scheduled and/or sent but not yet delivered.

File cabinet 340 is integrated with watch lists 310, allowing a user to select the name of an individual on a given watch list 310 and automatically access the records contained in file cabinet 340 that are associated with that individual and with the policies and reasons for that individual's inclusion on the selected watch list 310. Further, when viewing the contents of file cabinet 340, a user can annotate the records and add additional information that will serve to enhance the contents of file cabinet 340.

In the most preferred embodiments of the present invention, file cabinet 340 is context sensitive, so that selecting a student's name in a particular place in the user interface 224 displays the information most relevant to that part of the user interface 224. For example, if the file cabinet 340 is accessed from a watch list 310 that has been configured for tracking attendance information, then the student's attendance information will be displayed. On the other hand, if the file cabinet 340 is accessed from a watch list 310 that has been configured for tracking grades, then the student's grades will be displayed.

Although file cabinet 340 is designated as a separate storage location, those skilled in the art will appreciate that in certain applications, file cabinet 340 may be incorporated into database 223 of FIG. 2.

Login-logout mechanism 350 is a software mechanism that is accessed via user interface 224 and, in conjunction with security mechanism 226 of FIG. 2, provides user access control to network computer system 100 of FIG. 1. Using password and user identification protocols, including password recovery and challenge-response methods, access to network computer system 100 and the associated functions can be controlled and limited as necessary to safeguard and secure the information stored in database 223.

Report generator 360 is a software mechanism that is accessed via user interface 224 and used to create automated and ad-hoc reports based on the operation and functions of network computer system 100. Using report generator 360, a user can access previously created standard reports or create their own reports, to review and evaluate the various performance aspects of network computer system 100 as well as the individuals whose performance or attendance is being tracked. In the most preferred embodiments of the present invention, report generator 360 will also comprise a charting mechanism that provides for visual and graphical presentation of data associated with various policies and watch lists.

With the individual components of event mechanism 227 in mind, the overall process for tracking, reporting, and messaging for network computer system 100 can be more fully explained and illustrated.

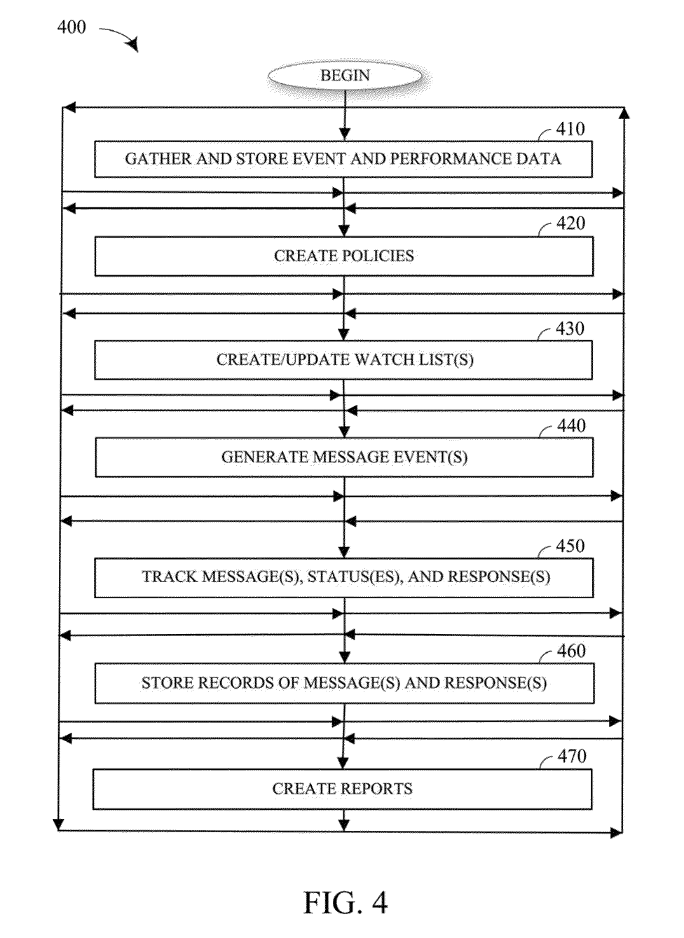

Referring now to FIG. 4, an overall process and method 400 for event tracking and messaging in accordance with a preferred embodiment of the present invention is shown. As shown in FIG. 4, the first step is generally to gather and store event and performance data (step 410). This step involves gathering the relevant data for the relevant population of users and subjects. For example, in an academic environment, step 410 would include populating a database 223 with student and teacher information, including classes to be taught and attended, as well as personal information such as addresses, phone numbers, birthdates, etc.

The creation or adoption of policies (step 420) is an important part of the overall event and performance tracking process. In some preferred embodiments of the present invention, users create policies by communicating the policy information (such as the threshold criteria) directly from the desktop computer 170, laptop computer 180, telephone 160 or smartphone 190. In other preferred embodiments, especially in the Application Service Provider (ASP) environment where data server 130 is operated in a hosted environment, users may discuss their preferred policies with the hosting provider or ASP, which creates the policies on data server 130. Policies may be created or adopted by any other suitable methods of inputting information known to those skilled in the art, whether currently known or developed in the future. Once the policies have been created (step 420), it is possible to create or update one or more watch lists 310 (step 430) based on those policies or other watch list criteria. As previously mentioned, each watch list 310 may have multiple members and an individual can appear on a plurality of watch lists 310. Once a watch list 310 has been created, it may be updated from time to time, in keeping with policy changes.

Once a policy is in place, it is possible to automatically generate message events based on the user-defined messaging criteria associated with each policy (step 440). In most cases, the message events will involve the initiation of a communication by network computer system 100 to the individual violating the threshold criteria of the policy, or to a related person. In a situation where the policy is based on a student's attendance at school functions (e.g., tardy to class, missing class, etc.) then the messages will typically be sent to that student or the student's parents or guardians. In the most preferred embodiments of the present invention, a “responsible party message,” which lists the people to whom a particular message was sent, can also be sent to the person responsible for the policy, such as a school principal or school district administrator. Most preferred embodiments also allow messages to be sent manually to subjects of a watch list 310 or to other individuals.

As previously indicated, there may be automated messages and manual messages associated with the violation of a policy. Automated messages or message events may be generated by communication server 225 and may take the form of email, SMS messages, automated phone calls, facsimile messages, social networking messages, etc. The generation of the message events may be escalating in nature, with the frequency and urgency of the messages escalating over time, based on the specific messaging criteria established for each policy and watch list 310. Manual messages may be generated by any authorized user and may be sent by network computer system 100 via communication server 225 or, if desired, the user can opt to utilize some other messaging medium or form of communication (e.g., personal visit).

With the generation of message events, network computer system 100 also provides a tracking system in most preferred embodiments that is configured to track messages, message statuses, and the responses (if any) that are received as input to network computer system 100 (step 450). In the most preferred embodiments of the present invention, network computer system 100 also generates message statuses from signals received after a message is sent. For example, network computer system 100 can detect a busy signal over an ISDN line, listen for a busy signal over an analog phone line, or receive a signal from an SMTP server indicating that an email message was undeliverable, and track and report the message status as “undelivered,” thereby alerting the user of network computer system 100 that the designated parties have not yet been successfully contacted.

Additionally, network computer system 100 can also listen over a phone line and distinguish between a person answering the phone and an answering machine, to track and report the status of a phone call message as delivered either to an answering machine or to a person. Similarly, network computer system 100 can receive signals from an SMS provider indicating whether an SMS message was received, and record or report an appropriate message status. Other statuses may be generated from any signal received as a result of sending a message. In most preferred embodiments, the message recipient may also provide a response to network computer system 100. For example, a phone message about a student's absence can allow the parents to press 1 to record a response excusing the absence. Alternatively, the parent could respond to an email message by emailing the school's attendance secretary, who could track the response in network computer system 100.

In the most preferred embodiments of the present invention, network computer system 100 will also store a variety of information regarding each message and each response (step 460), including the date and time that each occurred as well as the identity of the individual who received the message and provided a response. This creates an audit trail of the message events and responses in case some type of follow up or review is deemed necessary.

Finally, as more and more data and events are being monitored, it may be desirable at some point to generate reports (step 470) regarding the performance of network computer system 100 as well as overall information on the number and type of policies, numbers and identities of individuals appearing on various watch lists 310, number and types of messages, statuses and responses being tracked, etc. These types of reports can be generated by report generator 360.

As shown in FIG. 4, each step in method 400 is independent of the other steps and it is possible to skip steps and to repeat steps, as necessary, in order to accomplish the goals of tracking event and performance data as well as generating message events based on the results of the event and performance data. For example, the process of generating message events (step 440), once entered, may be repeated as many times as necessary in order to accomplish the objective of sending the appropriate number of messages. Similarly, steps in method 400 may be skipped, if necessary. For example, under certain circumstances, there may be a need to create a new watch list 310 (step 430), based on the creation or adoption of a new policy (step 420). However, since the policy was just created, it may take some period of time before any threshold criteria is violated that would trigger the creation of a message event (step 440). Accordingly, it is possible to simply continue with the gathering and storing of event and performance data (step 410) until such time as a threshold criteria is violated. In most preferred embodiments of the present invention, message events may be generated (step 440) based on policies established in step 420, without first creating a watch list 310 (step 430).

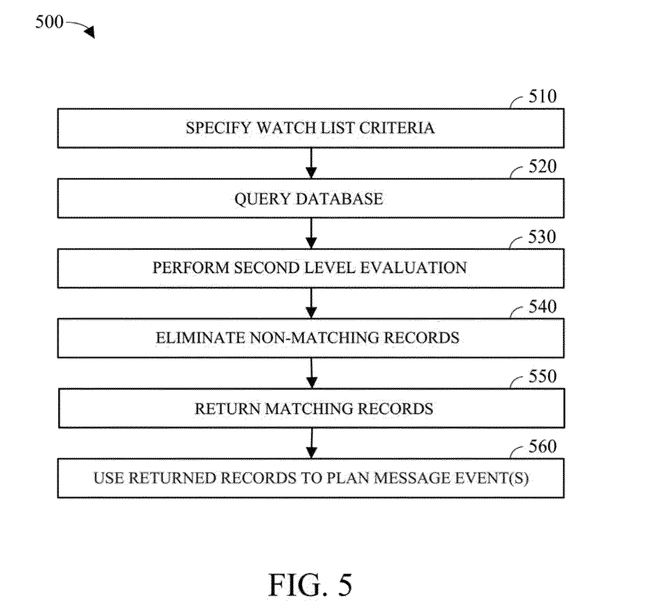

Referring now to FIG. 5, a method 500 for creating a watch list 310 for use with a network computer system 100 in accordance with a preferred embodiment of the present invention is depicted. As shown in FIG. 5, the user will first establish watch list criteria (step 510) for the watch list 310 (e.g., at least 4 absences or tardies during a selected date range, perfect attendance for a school term, good grades, or honor roll at the end of the school term).

With the watch list criteria established, network computer system 100 will query database 223 for all records matching the watch list criteria (step 520). In certain preferred embodiments of the present invention, the watch list criteria may be too complex for a simple query of the database 223. In those embodiments, network computer system 100 will query database 223 for all records matching part of the watch list criteria. In such embodiments, network computer system 100 will then perform a second level evaluation (step 530), and eliminate records that do not match the rest, or a different part, of the watch list criteria (step 540). Steps 530 and 540 may in some cases be repeated multiple times to eliminate records based on different parts of the watch list criteria. For example, a second level evaluation can be used to eliminate records where the events do not occur on consecutive school days, and it can be repeated to eliminate records where the events do not occur during the last 30 days of the current school term. This step may be accomplished by including an effective date range, as previously explained in conjunction with FIG. 3 above, or by other methods of filtering that will be recognized by those skilled in the art.

After completing the query of database 223 (step 520) and as many second level evaluations and eliminations (steps 530 and 540) as are necessary, network computer system 100 returns the records which match the watch list criteria (step 550). A user, such as a school or district administrator, may then use the returned records to plan message events, personal contacts, or other events (step 560). For example, the administrator may create a policy that sends letters to the parents of all students with more than 10 absences. The administrator may send message manually to students with more than 15 absences. The administrator may also learn the names of students with good grades for the last school term so as to congratulate them personally if they chance to meet in the school hallways.

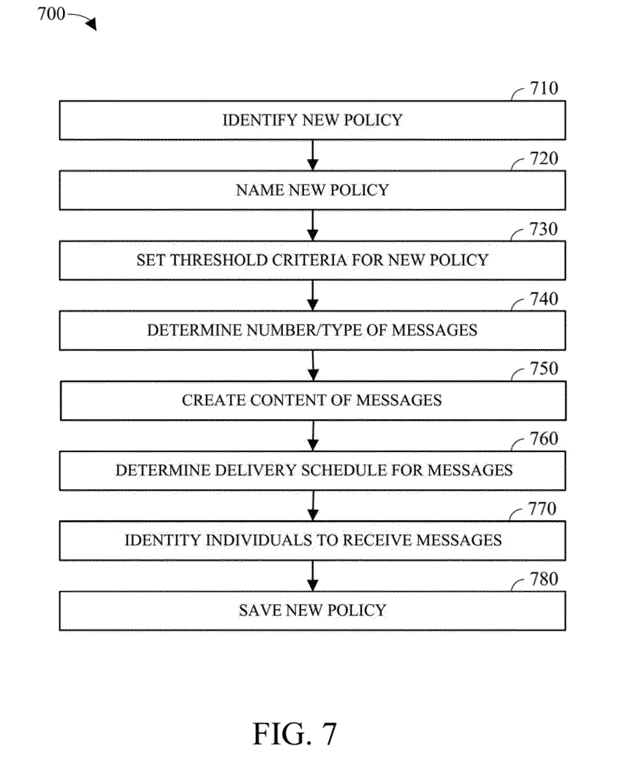

Referring now to FIG. 7, a method 700 for establishing a policy is depicted. As shown in FIG. 7, using policy planner 320 of FIG. 3, a user can create one or more policies, as necessary to monitor and report on the various events of interest for their specific organization. Once again, using an educational environment as an example, an administrator or teacher could create a policy for monitoring and reporting on the attendance of the students at a school.

A user will begin by identifying a new policy (step 710) and creating a name for the new policy (step 720) for including the policy in network computer system 100. In general, the new policy will be the result of a specific need or desire to monitor and track a specific behavior for the students in the school or the district and the name will reflect that need or desire. Next, the user will set the threshold criteria for evaluation of the student behavior (step 730). This may be as simple as specifying a certain number of tardies in a given quarter or semester. Or, it may be a complex criteria involving a group of different events (e.g., some combination of absences, excused absences, and tardies) in a given time period.

Next, the user will determine the number and type of messages that should be created and sent once the threshold criteria has been violated (step 740). This may include the creation and sending of text messages, automated phone calls, “tweets,” facsimile transmissions, emails, etc. The user can determine whether a given policy should have a single message event or multiple message events. It should also be noted that the messages may be automated or manual, as desired.

The user can also create the content of the messages, using network computer system 100 (step 750). So, the user could record a voice message that would be played during an automated phone call, for example. The user could also compose the text of an email, or hard copy letter to be sent. Next, the user can determine the delivery schedule for each of the messages (step 760). The timing and frequency can be adjusted as the user desires and each message event can have its own delivery schedule.

Then, the user can identify the individual or individuals that will receive the messages (step 770) and each message can have a different audience, as determined by the user. For example, some messages may be sent to the individual the message is regarding (such as a student who was absent), while other messages may be sent to a related person (such as an absent student's parent). Finally, the user can save the new policy (step 780) and the policy can optionally be used to generate a watch list 310 from the database 223 of network computer system 100. It should be noted that although the steps of method 700 are shown in a certain sequence, the steps may be performed in other sequences as well. For example, in some preferred embodiments, step 740, step 760, and step 770 are performed in the same part of the user interface 224, so that the individuals are identified (e.g. students and parents receive messages), the type of messages are determined (e.g. students receive emails and parents receive phone calls), and the delivery schedule for the messages is determined all in the same part of the user interface 224.

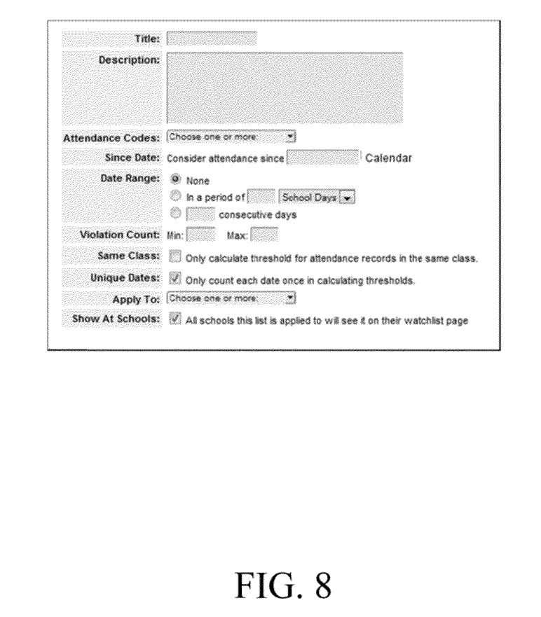

Referring now to FIG. 8, a schematic diagram of a user interface 800 for creating a watch list for use with network computer system 100 of FIG. 1 is depicted. As shown in FIG. 8, user interface 800 provides the user of network computer system 100 with the ability to provide a title for the watch list, as well as a description of the watch list. Additionally, the user can select the start date and specify the effective date range for the watch list. Further details for the inclusion of an individual on the watch list could include the use of an attendance code. The attendance code is simply the identification of the type of attendance event that is to be monitored for this specific watch list (e.g., tardy, absent, excused absence, medical appointment, etc.). It should be noted that more than one attendance code may be specified for each watch list.

To determine the threshold criteria for the watch list, the user will also specify the minimum and maximum number of specified events that must occur in the specified date range in order to the individuals to be identified and included on the relevant watch list. Other user-selectable variables include the option to specify the threshold for the same class, and to limit the tabulated occurrences to one per date (this allows the threshold to be set so as to consider an individual as being tardy only once a day instead of counting multiple tardies on a single day).

Finally, the watch list may be applied to a single physical location or facility, a single shift of workers, a single class, a single teacher, a single school, etc. so as to allow for the maximum possible flexibility to the user when building a given watch list. This is important since each user of network computer system 100 will likely have a different objective when creating their watch lists and the needs of each individual user will more likely be met with the additional flexibility of unique watch lists. However, it should be noted that network computer system 100 may be provided with a series of pre-programmed watch list templates, accounting for the most common situations for a given application. Once all of the user-selected elements shown in FIG. 8 have been set, these elements form the watch list criteria that will be used to generate a list of individuals that meet the specific parameters of the user-defined elements of the watch list. With the list of individuals created, the desired message or messages can be created and delivered to the appropriate individual or individuals using communication server 225 of FIG. 2.

Referring now to FIG. 9, a graphical representation of a timeline chart of school attendance depicting the number of excused and unexcused absences that occurred over a user selected period of time is illustrated. The timeline shown in FIG. 9 is a graphical representation of a timeline chart displayed by an events tracker 330 that is, in the preferred embodiment of the present invention, named an Attendance Events Tracker. However, various embodiments of the invention are contemplated, and the nomenclature could be adapted for other applications, including, for example, a Grade Events Tracker or a Cafeteria Balance Tracker. The date that messages were sent as a result of a certain policy's criteria for sending messages is annotated, in FIG. 9, by a rectangular icon with the letter A (“A Annotation”). This icon points to a specific location on the X-axis, and the specific location on the X-axis indicates the date that the specific policy was implemented. Additionally, the most preferred embodiments of the present invention provide for the addition of various indicia that may be used to identify specific events or items of interest to assist the user in interpreting the timeline.

The graphical representation of a timeline chart in FIG. 9 depicts time in units of years on the X-axis and also depicts an aggregate number of events for the selected organization, in this case, Parley School District. As depicted in FIG. 9, the displayed events are the aggregate number of unexcused absences, which are represented by an upper line, and the aggregate number of excused absences, which are represented by a lower line. Two annotations are depicted on the X-axis—the previously mentioned “A Annotation” and a second rectangular icon with the letter “B” (“B annotation”). A legend located to the right side of the graphical representation of a timeline chart identifies the specific events that are represented by the “A Annotation” and the “B Annotation.” “Annotation A” represents a point in time when an attendance campaign was implemented in response to a policy that instructed network computer system 100 to send a message to a user, such as a superintendent, that would inform the user if an associated threshold criteria had been violated (in this case, 2000 or more unexcused absences for the specified time period). This specific policy did not instruct the policy planner 320 to automatically send messages after the threshold criteria had been violated; however, the superintendent could then decide whether to send manual messages or to initiate the sending of automatic messages via network computer system 100.

After the superintendent receives the message that the threshold criteria of 2000 unexcused absences had been violated, the superintendent decided to implement an attendance campaign in which network computer system 100 automatically sends messages to all parents associated with students who had one or more unexcused absence during the last five days. The automatic messages contain language that encourages the students to attend school and reminds the parents to excuse their student's absence if the absence was excusable. After implementing the attendance campaign, the superintendent accesses the events tracker 330 and observed that the number of unexcused absences had decreased significantly. While the number of absences remained relatively constant, the classification of the absences into the proper categories may be significant to the school district for issues such as compliance, funding, etc.

Similarly, “Annotation B” refers to a situation where a policy has been created that instructs network computer system 100 to send a message to a user, such as a superintendent or principal, if the unexcused absence count for a single period, such as a day or a week, surpasses 500 total unexcused absences. On March 13th, because the unexcused absence count for the entire district surpasses 500 unexcused absences, network computer system 100 generated a message to the designated person or persons. The user then discussed the situation with with principals in the school district and discovered that a district band had taken a band trip and, in contravention to accepted policy, many parents of the band students had neglected to excuse their student's absence. Consequently, the superintendent created and sent an automatic message via network computer system 100 to all parents who had students who were enrolled in the district band and who were also absent during the time that the district band took the trip, reminding them to excuse their student's absences. This message could be referred to as “calling campaign for parents of band students who attended the district band trip” message.

In spite of the fact that many parents did call in to excuse their students, Events tracker 330 for tracking attendance as shown in FIG. 9 still depicts the actual attendance for each day as it was recorded at the end of the school day. Thus, the number of unexcused absences would not change even if parents called in to excuse absences; however, a user could select a “Graph Options” feature and activate a feature of network computer system 100 which would overlay a graph showing the aggregate number of excused absences and unexcused absences which had been adjusted to account for the most current totals, including any changes in unexcused absences counts that resulted from parents calling in to report that an unexcused absence for a student should be counted as an excused absence.

Further, because the superintendent had created “Annotation B,” when the superintendent or other authorized user examines events tracker 330 graph a week later, the superintendent is reminded that he or she had initiated the calling campaign for parents of band students who attended the district band trip, and the superintendent then selects the graph options feature to view an updated graph that showed the most current excused and unexcused absence counts. The superintendent could then observe that the number of unexcused absences for the period in which the band students had missed school during the band trip had now decreased by 80%. The superintendent could conclude that the calling campaign for parents of band students who attended the district band trip that is annotated by “Annotation B” was successful in decreasing the amount of unexcused absences and more accurately reflecting the actual attendance for the day in question.

In yet another preferred embodiment of the present invention, events tracker 330 recalculates the most current number of aggregate events, such as the aggregate number of excused absences and the aggregate number of unexcused absences, each time that a graphical representation of the time chart is displayed by events tracker 330 if the graphical representation of the time chart is displayed during a customizable grace period, such as two weeks. In this preferred embodiment, network computer system 100 takes “snapshots” of the metrics of events for points in time prior to the grace period and also stores a variable representing the most current point in time for which a given snapshot was taken. A snapshot is an image of the then current set of events. Then, at periodic time intervals, network computer system 100 takes additional snapshots for the time period beginning with the point in time for which the last snapshot was taken and ending with the beginning point of the grace period.

One reason for taking and storing a series of snapshots in this manner a simple matter of practicality. If the events tracker displays a time chart for a relatively long period of time such as one month or one year, then network computer system 100 can create and display the time chart for the requested period in less time because it is not necessary to calculate the aggregate number of events for the entire period of time but only for the grace period. Thus, if the superintendent who created “Annotation B” was using the another preferred embodiment, then when he or she created “Annotation B” he or she would include in “Annotation B” the number of unexcused absences for the point in time of interest.

After the superintendent had implemented the calling campaign for parents of band students who attended the district band trip, the superintendent could then revisit events tracker 330 during the grace period and network computer system 100 would display the most current aggregate number of excused absences and the most current aggregate number of unexcused absences, which should have decreased during the point in time of interest if parents had responded to the calling campaign for parents of band students who attended the district band trip. The superintendent could then compare the aggregate number of unexcused absences that he or she recorded in “Annotation B” to the current aggregate number of unexcused absences and make a judgment regarding the effectiveness of the calling campaign for parents of band students who attended the district band trip.

Additionally, FIG. 9 illustrates some additional salient features of events tracker 330, including a graphical user interface for allowing a user to modify the parameters in order to display attendance data for different organization. As shown in FIG. 9, the timeline graph is presently displayed for an entire school district (the “Parley School District”). However, by accessing the drop down menu feature shown in FIG. 9, a user (e.g., superintendent or other authorized administer) could click on the “down arrow” icon beside the Parley School District designation and the sub-organizations (e.g., list of constituent schools in the Parley School District) would be displayed. The user could then select a different sub-organization and network computer system 100 would then display modified line graphs for the excused and unexcused absences at the selected sub-organization, such as an elementary school in the Parley School District. Additionally, in the upper left corner of FIG. 9, an additional graphical user interface element comprises a plurality of hypertext links that when selected by a user (e.g., by clicking on one of the hypertext links) network computer system 100 will display an altered timeline, for a time period of 1 day, 5 days, 1 month, 3 months, 6 months, or 1 year.

Even though the examples herein have been directed towards a single school, those skilled in the art will recognize that the methods and network computer system 100 described herein could be adapted to other environments. For example, a school district could use network computer system 100 to establish attendance policies for the entire school district, and use network computer system 100 to track the performance of each school in the aggregate, or groups of students across grade levels or ethnicity, as well as the performance of individual students at each school. A school district administrator could establish different attendance policies and watch lists 310 for each school in the district, or establish district-wide policies and watch lists 310. Other hierarchical arrangements are possible, such as a company tracking workplace attendance across all branches of the company, or tracking attendance differently at each branch. Further, network computer system 100 could also be used to track other types of student performance. The grade point average (GPA) of the students could be tracked over a period of time to determine which students were at risk for failure or to identify the students who are eligible for academic honors.

Similarly, network computer system 100 of the present invention could be utilized to track worker attendance at a company location to ensure that workers are at work on time. Worker productivity could be monitored and reported as well. It would be possible for network computer system 100 of the present invention to be adapted for other similar purposes, regardless of the specific nature of the enterprise.

As will be appreciated by one skilled in the art, aspects of network computer system 100 disclosed herein may be embodied as a system, method or computer program product. Accordingly, aspects of network computer system 100 may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of network computer system 100 may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of network computer system 100 may be written in any combination of one or more programming languages, including an object oriented programming language such as Java, Smalltalk, C++ or the like and conventional procedural programming languages, such as the “C” programming language or similar programming languages. The program code may execute entirely on the user's computer as a stand-alone software package, partly on the user's computer and partly on a remote computer or entirely on the remote computer or server. In the latter scenario, the remote computer may be connected to the user's computer through any type of network 120, including a local area network (LAN) or a wide area network (WAN), or the connection may be made to an external computer (for example, through Internet 195 using an Internet Service Provider).

From the foregoing description, it should be appreciated that the system and method for event tracking and messaging disclosed herein present significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A network computer system comprising:
at least one server;
at least one database residing on the at least one server, the database comprising a plurality of records, the plurality of records comprising:
a plurality of records for a plurality of individuals; and
a plurality of records for a plurality of events, the plurality of events relating to the plurality of individuals; and
at least one user workstation, the at least one user workstation accessing at least one policy, the at least one policy comprising:
a start date from which the policy counts or monitors events;
an effective date range beginning on or after the start date, the effective date range ending on or before a current date;
a threshold criteria; and
a threshold algorithm, wherein the policy creates at least one message to at least one of the plurality of individuals if the threshold algorithm determines that at least one of the plurality of events occurring during the effective date range and relating to the at least one of the plurality of individuals violates the threshold criteria.

2. The network computer system of claim 1 further comprising a charting mechanism, the charting mechanism calculating at least one effect of a change made by a user to the at least one policy and subsequently displaying the at least one effect of a change on a display viewable by the at least one user workstation.

3. The network computer system of claim 1 further comprising:
at least one watch list, the watch list comprising:
at least one watch list criteria; and
at least one list, the at least one list comprising at least one reference to each individual in the plurality of individuals that meets the watch list criteria; and
a watch list sending mechanism, the watch list sending mechanism sending at least one message to at least one of the plurality of individuals, based on the at least one of the plurality of individuals being included on the watch list.

4. The network computer system of claim 1 further comprising a file cabinet, the file cabinet comprising a repository containing a plurality of data elements for each of the plurality of individuals, the plurality of data elements including at least one of: a plurality of attendance data; a plurality of performance data; a plurality of grade data; a class schedule; a photograph; a student ID number; a social security number; a cafeteria account balance; an address; a phone number; an email address; a plurality of parent information; a plurality of relationship information; a grade level; an expected graduation year; a list of past schools attended; and a list of a date and content for the at least one message.

5. The network computer system of claim 1 further comprising a policy planner, the policy planner displaying at least one chart, the at least one chart summarizing:
at least one policy effect for the at least one policy;
at least one action taken relative to the at least one policy when the at least one of the plurality of individuals violates the threshold criteria; and
a number of messages generated by the network computer system based on the at least one policy.

6. The network computer system of claim 1 further comprising an event tracker, the event tracker tracking data related to the plurality of events and the at least one message.

7. The network computer system of claim 1 further comprising a report generator, the report generator generating a plurality of automated and manual reports related to at least one of:
the plurality of events;
the plurality of individuals; and
the at least one message.

8. The network computer system of claim 1 wherein the at least one policy further comprises a unique identification number, the unique identification number being used to identify the at least one policy in at least one of a message and a report.

9. A network computer system comprising:
at least one server;
at least one database residing on the server, the database comprising a plurality of records, wherein the plurality or records comprises:
a plurality of records for a plurality of individuals; and
a plurality of records for a plurality of events, the plurality of events relating to the plurality of individuals; and
at least one user workstation, the at least one user workstation accessing at least one policy, the at least one policy comprising:
a start date from which the policy counts or monitors events;
an effective date range beginning on or after the start date, the effective date range ending on or before a current date, and the effective date range being not identical to the current date;
a threshold criteria;
a threshold algorithm, wherein the policy creates at least one message to at least one of the plurality of individuals if and only if the threshold algorithm determines that at least one of the plurality of events occurring during the effective date range and relating to the at least one of the plurality of individuals violates the threshold criteria; and
a charting mechanism, the charting mechanism calculating at least one effect of a change made by a user to the at least one policy and subsequently displaying the at least one effect of a change on a display viewable by the at least one user workstation;
at least one watch list, the watch list comprising:
at least one watch list criteria; and
at least one list, the at least one list comprising at least one reference to each individual in the plurality of individuals that meets the watch list criteria; and
a watch list sending mechanism, the watch list sending mechanism sending at least one message to at least one of the plurality of individuals, based on the at least one of the plurality of individuals being included on the watch list;
a file cabinet, the file cabinet comprising a repository containing a plurality of data elements for each of the plurality of individuals, the plurality of data elements including at least one of: a plurality of attendance data; a plurality of performance data; a plurality of grade data; a class schedule; a photograph; a student ID number; a social security number; a cafeteria account balance; an address; a phone number; an email address; a plurality of parent information; a plurality of relationship information; a grade level; an expected graduation year; a list of past schools attended; and a list of a date and content for the at least one message;
a policy planner, the policy planner displaying at least one chart, the at least one chart summarizing:
at least one policy effect for the at least one policy;
at least one action taken relative to the at least one policy when the at least one of the plurality of individuals violates the threshold criteria; and
a number of messages generated by the network computer system based on the at least one policy.
an event tracker, the event tracker tracking data related to the plurality of events and the at least one message;
a report generator, the report generator generating a plurality of automated and manual reports related to at least one of:
the plurality of events;
the plurality of individuals; and
the at least one message; and
a report generator, the report generator generating a plurality of automated and manual reports related to at least one of: the plurality of events; the plurality of individual; and the at least one message.

10. A computer implemented method for tracking and reporting attendance related information in a network computer system, the method comprising the steps of:
storing a plurality of records in a database, the plurality of records comprising:
a plurality of records for a plurality of individuals; and
a plurality of records for a plurality of events, the plurality of events relating to the plurality of individuals; and
accessing at least one policy via at least one user workstation, the at least one policy comprising:
a start date from which the policy counts or monitors events;
an effective date range beginning on or after the start date, the effective date range ending on or before a current date;
a threshold criteria; and
a threshold algorithm, wherein the policy creates at least one message to at least one of the plurality of individuals if the threshold algorithm determines that at least one of the plurality of events occurring during the effective date range and relating to the at least one of the plurality of individuals violates the threshold criteria.

11. The method of claim 11 further comprising the step of calculating at least one effect of a change made by a user to the at least one policy and subsequently displaying the at least one effect of a change on a display viewable by the at least one user workstation.

12. The method of claim 11 further comprising the steps of generating at least one watch list, the watch list comprising:
at least one watch list criteria; and
at least one list, the at least one list comprising at least one reference to each individual in the plurality of individuals that meets the watch list criteria; and
sending at least one message to at least one of the plurality of individuals, based on the at least one of the plurality of individuals being included on the watch list.

13. The method of claim 11 further comprising the step of storing a plurality of data for each of the plurality of individuals in a file cabinet, the plurality of data elements including at least one of a plurality of attendance data; a plurality of performance data; a plurality of grade data; a class schedule; a photograph; a student ID number; a social security number; a cafeteria account balance; an address; a phone number; an email address; a plurality of parent information; a plurality of relationship information; a grade level; an expected graduation year; a list of past schools attended;
and a list of a date and content for the at least one message.

14. The method of claim 11 further comprising the step of displaying at least one chart, the at least one chart summarizing:
at least one policy effect for the at least one policy;
at least one action taken relative to the at least one policy when the at least one of the plurality of individuals violates the threshold criteria; and
a number of messages generated by the network computer system based on the at least one policy.

15. The method of claim 11 further comprising the step of tracking data related to the plurality of events and the at least one message.

16. The method of claim 11 further comprising the step of generating a plurality of automated and manual reports related to at least one of:
the plurality of events;
the plurality of individuals; and
the at least one message.

17. A computer implemented method for tracking and reporting attendance related information in a network computer system, the method comprising the steps of:
storing a plurality of records in a database, the plurality of records comprising:
a plurality of records for a plurality of individuals; and
a plurality of records for a plurality of events, the plurality of events relating to the plurality of individuals; and
accessing at least one policy via at least one user workstation, the at least one policy comprising:
a start date from which the policy counts or monitors events;
an effective date range beginning on or after the start date, the effective date range ending on or before a current date;
a threshold criteria; and
a threshold algorithm, wherein the policy creates at least one message to at least one of the plurality of individuals if the threshold algorithm determines that at least one of the plurality of events occurring during the effective date range and relating to the at least one of the plurality of individuals violates the threshold criteria;
calculating at least one effect of a change made by a user to the at least one policy and subsequently displaying the at least one effect of a change on a display viewable by the at least one user workstation;
generating at least one watch list, the watch list comprising:
at least one watch list criteria; and
at least one list, the at least one list comprising at least one reference to each individual in the plurality of individuals that meets the watch list criteria; and
sending at least one message to at least one of the plurality of individuals, based on the at least one of the plurality of individuals being included on the watch list;
storing a plurality of data for each of the plurality of individuals in a file cabinet, the plurality of data elements including at least one of a plurality of attendance data; a plurality of performance data; a plurality of grade data; a class schedule; a photograph; a student ID number; a social security number; a cafeteria account balance; an address; a phone number; an email address; a plurality of parent information; a plurality of relationship information; a grade level; an expected graduation year; a list of past schools attended; and a list of a date and content for the at least one message;
displaying at least one chart, the at least one chart summarizing:
at least one policy effect for the at least one policy;
at least one action taken relative to the at least one policy when the at least one of the plurality of individuals violates the threshold criteria; and
a number of messages generated by the network computer system based on the at least one policy;
tracking data related to the plurality of events and the at least one message; and
generating a plurality of automated and manual reports related to at least one of:
the plurality of events;
the plurality of individuals; and
the at least one message.

18. An article of manufacture comprising software stored on a computer readable storage medium, the software comprising:
an application that includes a user interface for a user to access at least one database, the at least one database comprising a plurality of records, the plurality of records comprising:
a plurality of records for a plurality of individuals; and
a plurality of records for a plurality of events, the plurality of events relating to the plurality of individuals; and
an application that includes a user interface for a user to access at least one policy, the at least one policy comprising:
a start date from which the policy counts or monitors events;
an effective date range beginning on or after the start date, the effective date range ending on or before a current date;
a threshold criteria; and
a threshold algorithm, wherein the policy creates at least one message to at least one of the plurality of individuals if the threshold algorithm determines that at least one of the plurality of events occurring during the effective date range and relating to the at least one of the plurality of individuals violates the threshold criteria.

19. The article of manufacture of claim 18 comprising software stored on a computer readable storage medium, the software further comprising an application that calculates at least one effect of a change made by a user to the at least one policy and includes a user interface for displaying via a user workstation at least one effect of a change made by a user to the at least one policy.

20. The article of manufacture of claim 19 comprising software stored on a computer readable storage medium, the software further comprising an application that generates at least one watch list, the watch list comprising:
at least one watch list criteria; and
at least one list, the at least one list comprising at least one reference to each individual in the plurality of individuals that meets the watch list criteria.

21. The article of manufacture of claim 20 comprising software stored on a computer readable storage medium, the software further comprising an application that stores a plurality of data for each of the plurality of individuals in a file cabinet, the plurality of data elements including at least one of a plurality of attendance data; a plurality of performance data; a plurality of grade data; a class schedule; a photograph; a student ID number;
a social security number; a cafeteria account balance; an address; a phone number; an email address; a plurality of parent information; a plurality of relationship information; a grade level;
an expected graduation year; a list of past schools attended; and a list of a date and content for the at least one message.

22. The article of manufacture of claim 21 comprising software stored on a computer readable storage medium, the software further comprising an application that includes a user interface for a user to access at least one chart, the at least one chart summarizing:
at least one policy effect for the at least one policy;
at least one action taken relative to the at least one policy when the at least one of the plurality of individuals violates the threshold criteria; and
a number of messages generated by the network computer system based on the at least one policy.

23. The article of manufacture of claim 22 comprising software stored on a computer readable storage medium, the software further comprising
an application that tracks data related to the plurality of events and the at least one message.

24. The article of manufacture of claim 23 comprising software stored on a computer readable storage medium, the software further comprising
an application that generates a plurality of automated and manual reports related to at least one of:
the plurality of events;
the plurality of individuals; and
the at least one message.

25. An article of manufacture comprising software stored on a computer readable storage medium, the software comprising:
an application that includes a user interface for a user to access at least one database, the at least one database comprising a plurality of records, the plurality of records comprising:
a plurality of records for a plurality of individuals; and
a plurality of records for a plurality of events, the plurality of events relating to the plurality of individuals; and
an application that includes a user interface for a user to access at least one policy, the at least one policy comprising:
a start date from which the policy counts or monitors events;
an effective date range beginning on or after the start date, the effective date range ending on or before a current date;
a threshold criteria; and
a threshold algorithm, wherein the policy creates at least one message to at least one of the plurality of individuals if the threshold algorithm determines that at least one of the plurality of events occurring during the effective date range and relating to the at least one of the plurality of individuals violates the threshold criteria;
an application that calculates at least one effect of a change made by a user to the at least one policy and includes a user interface for displaying via a user workstation at least one effect of a change made by a user to the at least one policy;
an application that generates at least one watch list, the watch list comprising:
at least one watch list criteria; and
at least one list, the at least one list comprising at least one reference to each individual in the plurality of individuals that meets the watch list criteria;
an application that stores a plurality of data for each of the plurality of individuals in a file cabinet, the plurality of data elements including at least one of a plurality of attendance data; a plurality of performance data; a plurality of grade data; a class schedule; a photograph; a student ID number; a social security number; a cafeteria account balance; an address; a phone number; an email address; a plurality of parent information; a plurality of relationship information; a grade level; an expected graduation year; a list of past schools attended; and a list of a date and content for the at least one message;
an application that includes a user interface for a user to access at least one chart, the at least one chart summarizing:
at least one policy effect for the at least one policy;
at least one action taken relative to the at least one policy when the at least one of the plurality of individuals violates the threshold criteria; and
a number of messages generated by the network computer system based on the at least one policy;
an application that tracks data related to the plurality of events and the at least one message;
an application that generates a plurality of automated and manual reports related to at least one of:
the plurality of events;
the plurality of individuals; and
the at least one message.
